(19) United States
(12) Patent Application Publication
(10) Pub. No.: US 2012/0199564 A1
(43) Pub. Date: Aug. 9, 2012

(54) POWDER-DELIVERY APPARATUS FOR LASER-CLADDING

(75) Inventors: John F. WASHKO, JR., Canton, CT (US); Harrell Keith Parker, Stephenville, TX (US); Stephen W. Brookshier, Enfield, CT (US)

(73) Assignee: Coherent, Inc., Santa Clara, CA (US)

(21) Appl. No.: 13/338,597

(22) Filed: Dec. 28, 2011

Related U.S. Application Data
(60) Provisional application No. 61/441,107, filed on Feb. 9, 2011.

(51) Int. Cl. B23K 26/00

(52) U.S. Cl. 219/121.63

(57) ABSTRACT

Powder-delivery apparatus for delivering powdered cladding-material into the vicinity of a laser-beam spot includes a plurality of powder-delivery modules. Each of the modules is arranged to receive the cladding-material and deliver the cladding-material through a plurality of nozzles. The position of the nozzles in the modules with respect to the laser-beam spot is adjustable in three Cartesian axes. The modules are selectively removable from, and attachable to the apparatus. Nozzles in any one of the modules can be selectively prevented from delivering cladding-material.

### PRIORITY CLAIM

This application claims priority of U.S. Provisional Patent Application No. 61/441,107, filed Feb. 9, 2011, the complete disclosure of which is hereby incorporated by reference.

### TECHNICAL FIELD OF THE INVENTION

The present invention relates in general to apparatus for laser-assisted cladding (laser-cladding) of metal surfaces. The invention relates in particular to apparatus for delivering powdered cladding-material onto a surface in the presence of a high-power laser-beam.

### DISCUSSION OF BACKGROUND ART

Laser-cladding has been developed by the laser industry to solve a multitude of industrial applications. Laser-cladding involves directing a high power laser-beam, for example a beam having a total power of several kilowatts (kW) on to a surface to be clad while directing cladding-material in the form of powder into the laser-beam on the surface. The powder melts and hardens to form the cladding. Laser-cladding can be used to repair a worn surface using an identical material; build a layer of different properties onto a base material; or construct an entire near net-shape object directly from powder with specific properties. The powder can be delivered simply by gravity through a suitable nozzle, or entrained in a pressure-fed inert gas. The pressurized gas method lends itself to cladding in other attitudes than the horizontal plane and can even be used to generate three-dimensional shapes.

A preferred laser-beam source is a two-dimensional array of diode-lasers made by stacking one directional arrays of diode-lasers known in the art as diode-laser bars. Such two dimensional arrays are commercially available with a total delivered power of over 1 kW. Several stacks may be used to provide extra power. FIG. 1 schematically illustrates a modular laser-head assembly 10 arranged for projecting a laser-beam having a rectangular cross-section. Such a unit is available as a HighLight™ D-Series Unit, from Coherent Inc., of Santa Clara, California. Unit 10 includes a bar-stack module 12 which can hold two or more diode-laser bar stacks depending on power required. Attached to module 12 is a collimator optics module 14 including a plurality of inverse Galilean cylindrical lens pairs, arranged to collimate the output of the plurality of diode-laser bar stacks in module 12 in one axis (here the fast-axis) of the diode-laser bars. A condenser optics module 16 includes one or more elements arranged to project the one-axis collimated output into an elongated rectangular beam projection 18 on a working plane at a specified working distance from the condenser optics module. A surface to be clad would be placed in the working plane with provisions for relative motion between the surface and beam-projection 18 to deposit powdered cladding-material onto the surface. The slow-axis and fast-axis of the diode-laser bars are designated arbitrarily herein as the x-axis and y-axis respectively of a Cartesian set, with the beam propagation axis designated as the z-axis.

In unit 10, module 12 can be interchanged for a similar module having more or less diode-laser bar stacks for selecting, respectively, more or less total power. Inverse Galilean pairs in module 14 are cartridge-mounted and correspondingly interchangeable to adapt to a particular configuration of module 12. Elements in module 16 are mounted on a sliding tray 20, and accordingly are also interchangeable. This interchangeability of modules provides that laser-beam projection 18 can have a wide range of length and width to adapt to various cladding tasks. Powder delivery (cladding) apparatus can be attached to unit 10 via a flange 22 on module 16. Only sufficient description of unit 10 is provided here for illustrating a laser-beam source which can be used with inventive cladding apparatus described herein. A detailed description of laser-head assembly 10 is provided in U.S. patent application Ser. No. 13/082,171, filed Apr. 7, 2011, assigned to the assignee of the present invention, and the complete disclosure of which is hereby incorporated herein by reference. FIG. 2 schematically illustrates a prior-art powder-delivery (cladding-head) apparatus 30, suitable for use with a laser-beam-source of which beam source 10 of FIG. 1 is merely one particular example. Such a source is referred to hereinafter as a laser-head. Cladding-head 30 includes a mounting flange 32 having a fixed member 33 attachable to a corresponding flange on a laser head, for example, flange 20 of laser head 10 of FIG. 1. Flange 32 includes a movable member 34 attached to fixed member 33 and is adjustable in x and y with respect to member 32 by adjusting screws 38 and 40.

A four-sided hollow body 36, open at both ends is suspended from movable member 34 of flange 32. Attached to opposite sides of body 36 are powder-delivery plates 42A and 42B, seen in side-elevation in FIG. 2. Such plates typically include an internal manifold connection a plurality of channels terminating in a corresponding plurality of orifices at the delivery end of the plates. This detail is not shown in FIG. 2 but is discussed in descriptions of embodiments of the present invention presented further hereinbelow. Powder from a reservoir thereof (not shown) is fed into plates 42A and 42B via fixtures 44A and 44B, respectively and delivered from the orifices into the vicinity of the laser-beam projection 18 in the working plane. In the drawing of FIG. 2, the delivery orifices of the delivery plates would be aligned parallel to the x-axis of the laser-beam. The powder is typically entrained in an inert delivery gas, such as nitrogen, at high pressure. The x-y position of the delivery orifices with respect to laser-beam projection 18 is adjustable by adjusting screws 38 or 40.

Controlled application of a suitable powder to a interaction point of the laser-beam with substrate material being clad is fundamental to laser-cladding technology. The powder must be precisely placed with respect to the laser energy and the substrate material in order for the process to be successful in producing a high quality, well bonded layer of the desired thickness and shape. The powder delivery nozzle (orifice) configuration has great impact on the clad deposit produced by the process. There are several different configurations of nozzles currently in use. The most common are: arrays of holes (or slots) in a plate for square or line shaped cladding, concentric cones with the powder ejecting from between the gap between the cones, or discrete nozzles singularly or in combination ejecting the powder simultaneously to the laser-beam interaction point for thin line clad deposition.

In prior-art cladding apparatus the powder distribution shape in these configurations is not able to be changed without removing and replacing the emitting nozzle at best, or completely changing the cladding head at worst. Similarly, the overall size of the deposit is not currently capable of being physically adjusted at the nozzle output other than by injecting more or less powder into the delivery gas stream or using higher or lower delivery gas volume or pressure. Line-shaped clad deposits are desirable for depositing a large amount of material over a large area, be it on flat shapes or round shafts. Square-shaped claddings are desirable for building up thicker layers and controlling the net shape better; and circular shapes are desirable for producing thin lines for the greatest control in applying clad deposits over small features or making 3D near-net shapes. There is a need for a cladding-head that can accommodate the above-discussed variations.

### SUMMARY OF THE INVENTION

The present invention is directed to apparatus for delivering powdered cladding-material into the vicinity of a laser-beam spot defined by a laser-beam projected into a working plane. In one aspect, apparatus in accordance with the present invention comprises a hollow body through which the laser beam is projected onto the working plane. At least a first powder-delivery module removable attached to the hollow body and arranged to receive the powdered cladding-material to be delivered. The powder-delivery module includes one or more nozzles for delivering the received powdered cladding-material into the vicinity of the laser-beam projection in the working plane. The position of the one or more nozzles of the powder delivery module with respect to the laser-beam projection on the working plane is adjustable in x, y, and z Cartesian axes.

In a preferred embodiment of the inventive apparatus, the powder-delivery module includes a plurality of nozzles for delivering the received powdered cladding-material. The powder delivery module further includes an arrangement for blocking a selected one or more of the nozzles such that only unblocked nozzles deliver the received powdered cladding-material.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates a prior-art laser head for producing a high power laser-beam suitable for laser-cladding.

FIG. 2 schematically illustrates a prior-art cladding head for delivering powdered cladding-material into the vicinity of a laser-beam on a surface to be laser-clad.

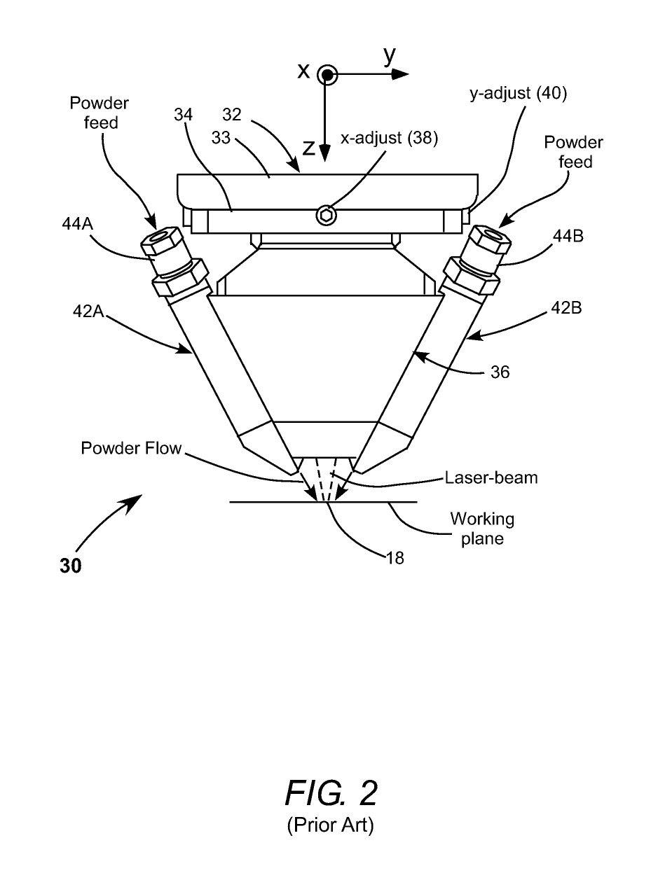

FIG. 3 schematically illustrates a preferred embodiment of a cladding head in accordance with the present invention including replaceable powder-delivery plates having an aligned plurality of powder-delivery nozzles with means to adjust the number of nozzles in the aligned plurality thereof through which powdered cladding-material is delivered.

FIG. 3A schematically illustrates detail of one configuration of the cladding-head of FIG. 3 having two pairs of powder-delivery plates the plurality of nozzles in each pair thereof aligned parallel to each other, with nozzles in one pair aligned parallel to the x-axis and nozzles in the other pair aligned parallel to the y-axis of a laser-beam similar to that delivered by the laser-head of FIG. 1, with the number of nozzles in each plate through which powder is delivered being selectively adjustable.

FIG. 3B schematically illustrates detail of another configuration of the cladding-head of FIG. 3 similar to the configuration of FIG. 3A but having only the x-axis aligned powder-delivery plates.

FIG. 4A and FIG. 4B schematically illustrates detail of a powder delivery plate in the cladding-head of 3B including a manifold having adjustment plugs adjustable to selectively isolate powder delivery nozzles from a powder supply.

### DETAILED DESCRIPTION OF THE INVENTION

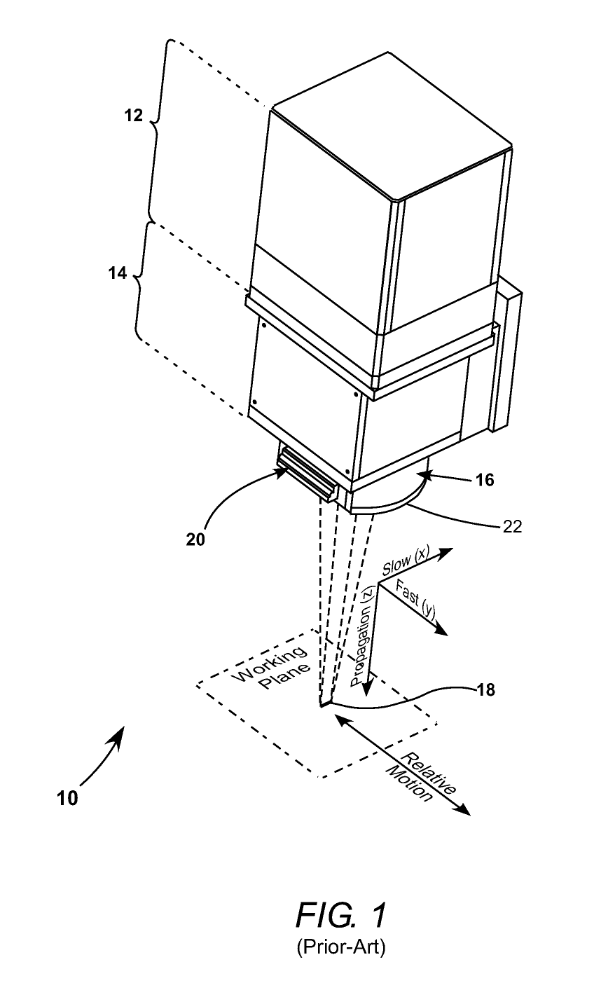

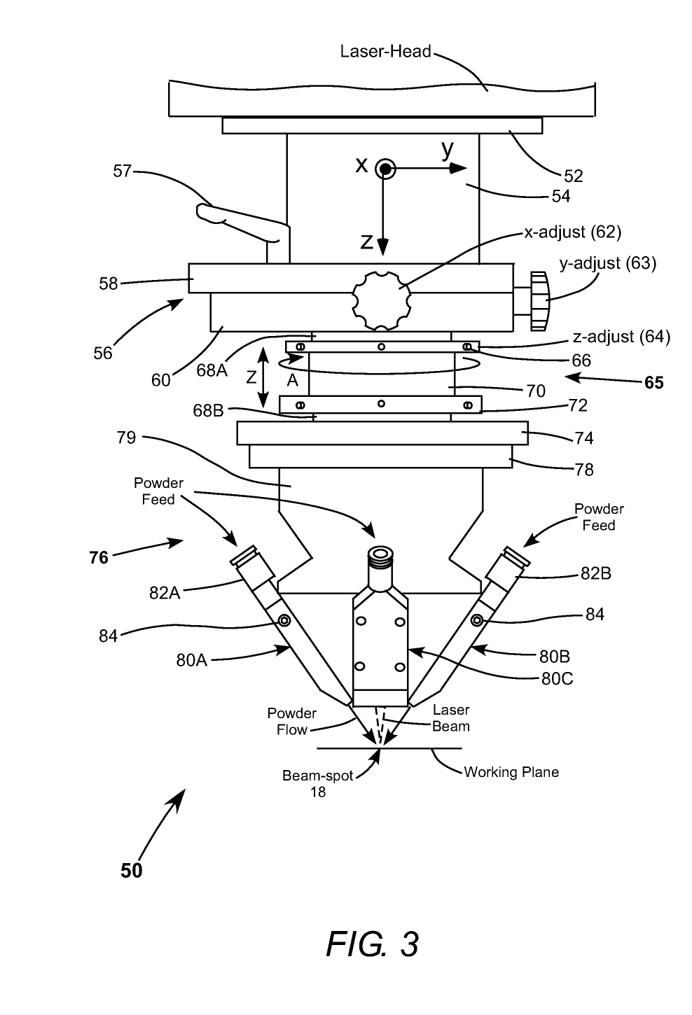

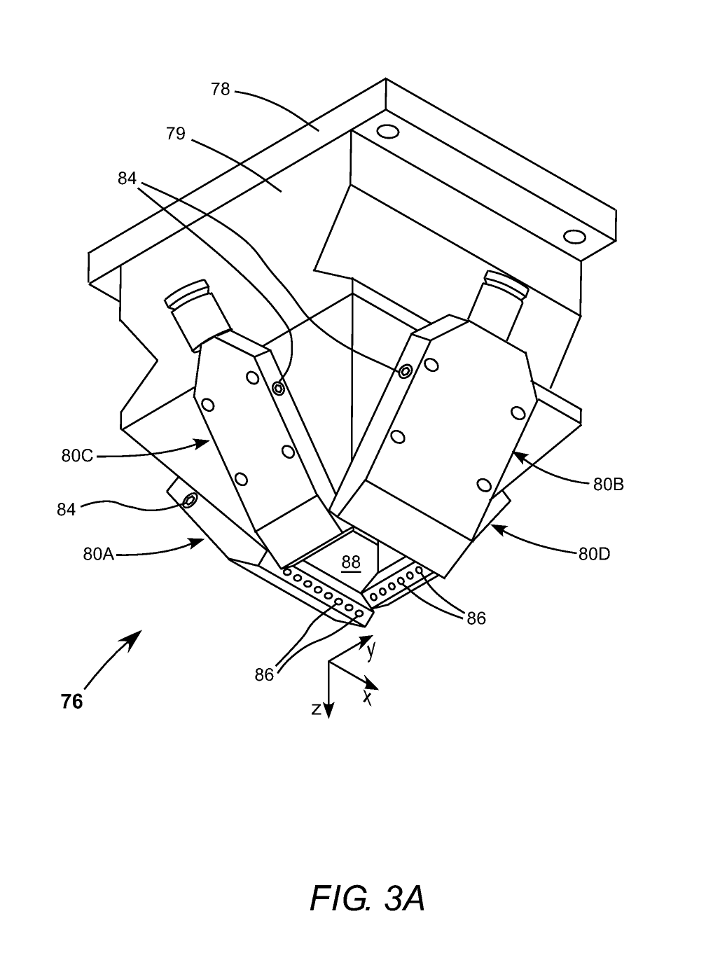

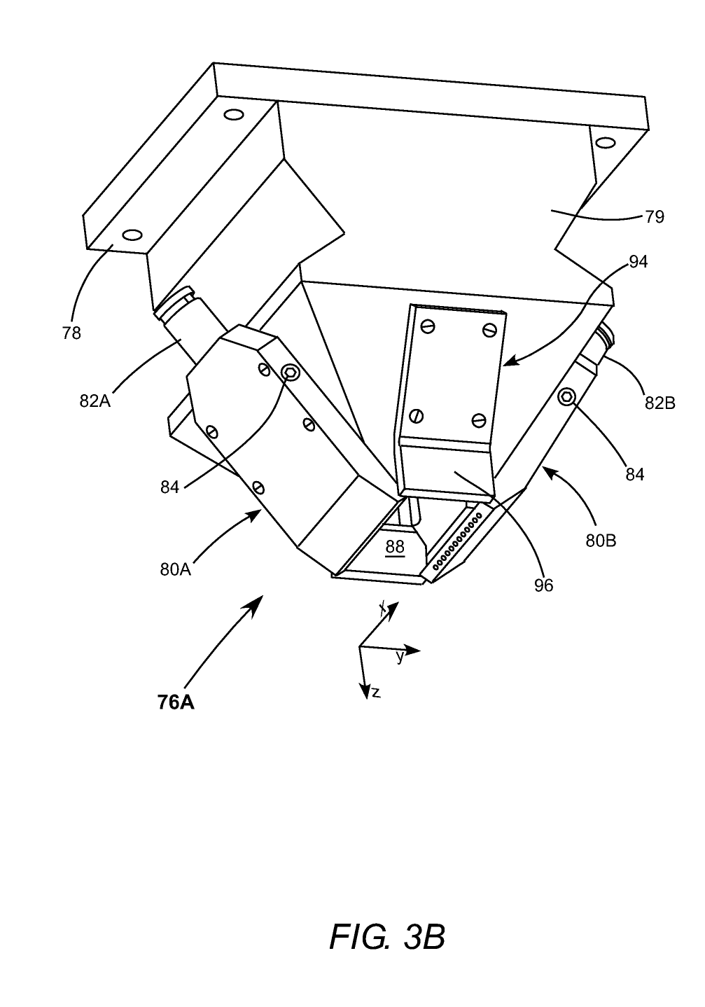

Continuing with reference to the drawings, wherein like components are designated by like reference numerals, FIG. 3 schematically illustrates a preferred embodiment 50 of a laser-cladding-head in accordance with the present invention. Cladding-head 50 includes a flange 52 for attaching the cladding head to a laser-head similar to that of FIG. 1.

An arrangement 56 is provided for providing x-y adjustment of the cladding head with respect to a laser-beam delivered by the laser-head and propagating through the laser head. A fixed member 58 of arrangement 56 is attached to flange 52 via a cylindrical extension 54. A movable member 60 of arrangement 56 is movably attached to fixed member 58. The x-position and y-position of member 56 with respect to member 58 are adjustable by knobs 62 and 64, respectively. The relative x-y position of members 58 and 60 can be locked by a cam lever 57.

The x-y adjustment method described above is but one suitable mechanism for achieving the adjustment. Those skilled in the art will recognize that other mechanisms could be used without departing from the spirit and scope of the present invention. Such mechanisms include jacking screws, cams, sliding wedges, sliding shims or any mechanism capable of providing linear motion in either two axes independently or simultaneously. In addition the x-y locking mechanism could take any number of forms including locking screws, jacking screws with locknuts, locking clamps, locking wedges or other devices used to restrain motion between moving objects.

A z-axis adjustment assembly 65 is attached to movable member 60 of the x-y adjustment via a threaded cylinder 68A attached to the movable member. A complimentary threaded cylinder 68B is attached to a mounting flange 74. A rotatable threaded collar 70 connects cylinders 68A and 68B. Rotation of collar 70 is accomplished via an adjustment ring 64 having protruding pegs 66 to facilitate rotation of the collar as indicated by arrow A. Rotation of adjustment ring 64 translates into Z axis motion of the collar with respect to the sleeve, by moving cylinders 68A and 68B toward or away from each other, depending on the direction of rotation of collar 70. The rotation position of the collar can be locked by a locking-ring 72. Here again, this mechanism is only one of a number of possible mechanisms.

Continuing with reference to FIG. 3, and with reference, in addition, to FIG. 3A, a powder delivery assembly 76 is attached, via a flange 78 thereof, to flange 74 of the z-axis adjustment assembly. Powder-delivery assembly 76 includes a hollow four-sided body 79 to which are attached one pair of powder-delivery modules (plates) 80A and 80B, and another pair of powder-delivery modules 80C and 80D (module 80D is not visible in FIG. 3). Each powder-delivery module includes a plurality of nozzles 86 with orifices thereof arranged in-line. Cladding-powder from a source thereof (not shown) is fed into the modules entrained in an inert-gas under pressure via fixtures 82A-D. A manifold within each module distributes the powder among the nozzles. Each, module here, also includes plugs 84, which can be inserted or withdrawn, here, by screw-action, into or out of the manifold to select a number of nozzles through which powder can flow. This nozzle-selection process is described in detail further hereinbelow.

In powder-delivery assembly 76, lines of nozzles in modules 80A and 80B are parallel to each other and parallel to the x-axis of the laser-beam passing through the assembly via aperture 88 therein. Lines of nozzles in modules 80C and 80D are parallel to each other and parallel to the y-axis of the laser-beam. This arrangement is suitable for square-shaped claddings discussed above as being suitable for building up thick cladding-layers. The x-y adjustment assembly 56 and the z-axis adjustment assembly 65 provide that the nozzle positions of modules 80A-D are, collectively, independently adjustable in three axes with respect to laser-beam spot 18 in the working plane.

FIG. 3B schematically illustrates another possible configuration 76A of powder-delivery assembly 76. Here modules 80C and 80D of FIG. 3A have been removed and replaced with passive blocking plates 94. Plates 94 have downward-extending portions 96 thereof arranged to minimize migration of powder in the x-axis direction out of the laser-beam spot. This configuration of powder modules is for above-discussed line-shaped clad-deposits suitable for depositing a large amount of cladding-material over a large area.

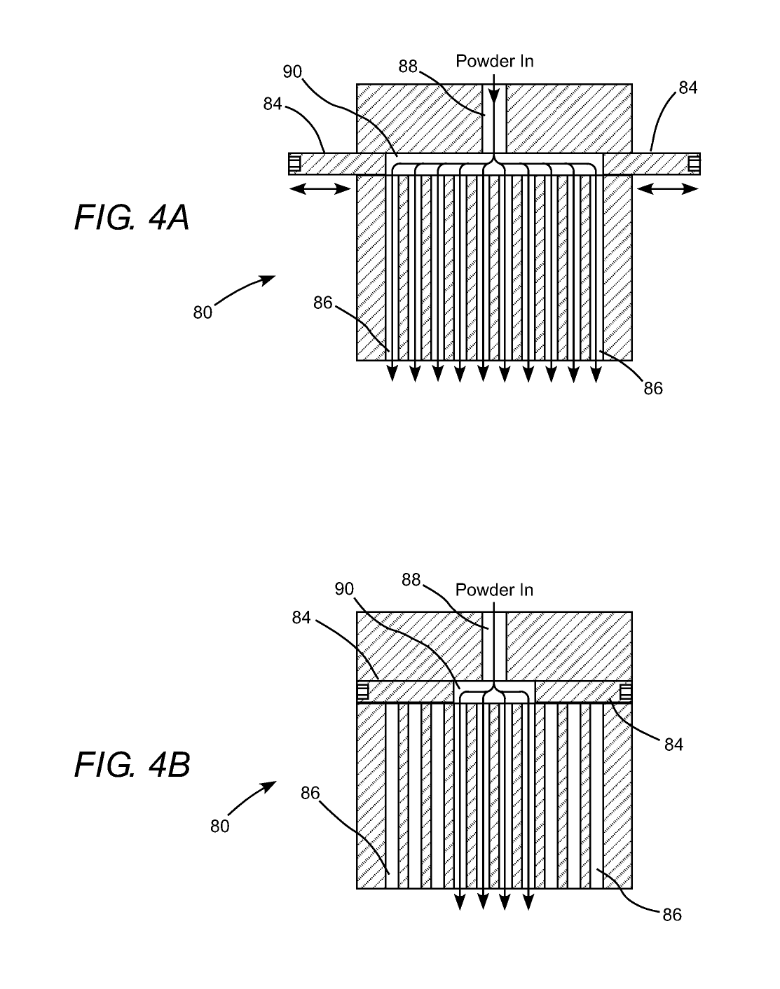

FIG. 4A and FIG. 4A schematically illustrate details of plug-arrangements described above for limiting the amount of active nozzles in a powder delivery module 80. The shape of the modules is depicted, here, in simplified form. Powder is injected via a conduit 88 into a manifold 90 from which nozzles 86 extend. In FIG. 4A plugs 84 are shown sufficiently withdrawn from manifold 90 such that all, here ten, nozzles can transmit the injected powder. In FIG. 4B plugs 80 are inserted into manifold 90 such that only a central four of nozzles 86 can transmit powder. The examples of FIGS. 4A and 4B are for symmetrical arrangement of active nozzles. Clearly with the manifold-plug mechanism depicted, asymmetrical arrangements are also possible. Other mechanisms are possible for selecting active nozzles. One very simple mechanism would be selectively disabling any nozzle by inserting a pin or the like in the delivery-end of the nozzle. This could be used for example to change the spacing between active nozzles.

In summary the present invention is described above with reference to a preferred embodiment and certain specific examples. The invention, however, is not limited to this embodiment and examples. Rather, the invention is defined by the claims appended hereto.

What is claimed is:

1. Apparatus for delivering powdered cladding-material into the vicinity of a laser-beam projection defined by a laser-beam projected into a working plane, the apparatus comprising:
a hollow body through which the laser beam is projected onto the working plane;
at least a first powder-delivery module removable attached to the hollow body and arranged to receive the powdered cladding-material to be delivered, the powder-delivery module including one or more nozzles for delivering the received powdered cladding-material into the vicinity of the laser-beam projection; and
wherein the position of the one or more nozzles of the powder delivery module with respect to the laser-beam projection on the working plane is adjustable in x, y, and z Cartesian axes.

2. The apparatus of claim 1 wherein the powder-delivery module includes a plurality of nozzles for delivering the received powdered cladding-material, and an arrangement for blocking a selected one or more of the nozzles such that only unblocked nozzles deliver the received powdered cladding-material.

3. The apparatus of claim 2, wherein the powder-delivery module includes a conduit for receiving the delivered powdered cladding-material the conduit and the nozzles being in communication with a manifold extending laterally across the powder-delivery module, and wherein nozzles are selectively blocked by at least one plug selectively positionable in the manifold to interrupt communication between the manifold and one or more of the nozzles.

4. The apparatus of claim 3, wherein there are two selectively positionable plugs, one at each end of the manifold.

5. The apparatus of claim 1, wherein the position of the nozzles of the powder delivery module with respect to the laser-beam spot is adjustable in x, y, and z Cartesian axes by correspondingly adjusting the position of the hollow body.

6. The apparatus of claim 5, wherein there are first, second, third, and fourth powder-delivery modules removable attached to the hollow body, each with an aligned plurality of nozzles, with the first and second powder-delivery modules arranged such that the pluralities of nozzles thereof are spaced apart and parallel to each other, and with the third and fourth powder-delivery modules arranged such that the pluralities of nozzles thereof are spaced apart and parallel to each other, and perpendicular to the pluralities of nozzles in the first and second powder-delivery modules.

7. The apparatus of claim 6, wherein the laser-beam has a propagation-axis, and a fast-axis and a slow-axis perpendicular to each other and perpendicular to the propagation axis, and wherein the pluralities of nozzles of the first and second powder-delivery modules are aligned with the slow-axis of the laser beam, and the pluralities of nozzles of the first and second powder-delivery modules are aligned with the fast-axis of the laser beam.

8. The apparatus of claim 6, wherein each of the powder-delivery modules includes a plurality of nozzles for delivering the received powdered cladding-material, and an arrangement for blocking a selected one or more of the nozzles such that only unblocked nozzles deliver the received powdered cladding-material.

9. Apparatus for delivering powdered cladding-material into the vicinity of a laser-beam projection defined by a laser-beam projected into a working plane, the apparatus comprising:
at least a first powder-delivery module arranged to receive the powdered cladding-material to be delivered, the powder-delivery module including a plurality of nozzles spaced apart and aligned for delivering the received powdered cladding-material into the vicinity of the laser-beam projection on the working plane; and
an arrangement for blocking a selected one or more of the nozzles such that only unblocked nozzles deliver the received powdered cladding-material.

10. The apparatus of claim 9, wherein the powder delivery module includes a conduit for receiving the powdered cladding-material to be delivered.

11. The apparatus of claim 10, wherein the conduit and the nozzles are in communication with a manifold extending laterally across the powder-delivery module, and wherein nozzles are selectively blocked by at least one plug selectively positionable in the manifold to interrupt communication between the manifold and one or more of the nozzles.

12. The apparatus of claim 11, wherein there are two selectively positionable plugs, one at each end of the manifold.

13. The apparatus of claim 9, wherein there are first, second, and third, and fourth powder-delivery modules each thereof including a plurality of nozzles spaced apart and aligned for delivering the received powdered cladding-material into the vicinity of the laser-beam spot, and each thereof includes an arrangement for blocking a selected one or more of the nozzles such that only unblocked nozzles deliver the received powdered cladding-material.
